(19) United States
(12) Patent Application Publication
(10) Pub. No.: US 2008/0252989 A1
(43) Pub. Date: Oct. 16, 2008

(54) Variable Focus Lens

(75) Inventors: Bernardus Hendrikus Wilhelmus Hendriks, Eindhoven (NL); Stein Kuiper, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,607

(22) PCT Filed: May 18, 2005
(86) PCT No.: PCT/IB05/51614

§ 371 Date: Nov. 27, 2006

(30) Foreign Application Priority Data
May 25, 2004 (EP) 04102276.5

(51) Int. Cl. G02B 3/14

(52) U.S. Cl. 359/666

(57) ABSTRACT

Disclosed is a variable focus lens, having an optical axis, comprising: a fluid chamber, the fluid chamber comprising a first fluid and an axially displaced second fluid, the fluids being non-miscible, in contact over a meniscus and having different indices of refraction; a fluid contact layer arranged on the inside of the chamber wall; a first electrode separated from the first fluid and second electrode by the fluid contact layer; a second electrode acting on the second fluid; the fluid contact layer having a wettability by the second fluid which varies under the application of a voltage between the first electrode and the second electrode, such that the shape of the meniscus varies in dependence on said voltage; wherein the fluid chamber is shaped such that an angle formed between the wall of the chamber and the optical axis decreases along the length of the optical axis.

This invention relates to a variable focus lens comprising a cell containing a first and second fluid which are held in contact over a meniscus. The shape of the meniscus, and hence the focus of the lens, can be controlled by the application of a voltage to the cell. Such lenses are sometimes known as electrowetting lenses.

A fluid is a substance that alters its shape in response to any force, that tends to flow or to conform to the outline of a chamber containing it, and includes gases, vapours, liquids and mixtures of solids and liquids capable of flow.

In general, to control the meniscus in a typical electrowetting lens, a relatively high voltage is required, typically 100 V. For portable applications, such as portable cameras and the like, this voltage is too high to be practicable, and it is desirable to utilise a lower voltage if possible. Two known ways of reducing the voltage required are to reduce the thickness of the insulating layer surrounding the electrodes and to reduce the interfacial tensions of the two liquids and the wall. The required voltage can be obtained using a dc-todc converter that operates from a battery.

PCT patent application WO03/069380 discloses a variable focus lens first and second immiscible fluids in contact over a meniscus. The shape of the meniscus is caused to alter by application of a voltage across a pair of electrodes positioned in the lens body.

According a first aspect of the present invention, there is provided a variable focus lens, having an optical axis, comprising: a fluid chamber, the fluid chamber comprising a first fluid and an axially displaced second fluid, the fluids being non-miscible, in contact over a meniscus and having different indices of refraction; a fluid contact layer arranged on the inside of the chamber wall; a first electrode separated from the first fluid and second electrode by the fluid contact layer; a second electrode acting on the second fluid; the fluid contact layer having a wettability by the second fluid which varies under the application of a voltage between the first electrode and the second electrode, such that the shape of the meniscus varies in dependence on said voltage; wherein the fluid chamber is shaped such that an angle formed between the wall of the chamber and the optical axis decreases along the length of the optical axis.

Preferably, the first fluid includes an insulating fluid and the second fluid includes a conducting fluid.

Preferably, the angle decreases along the optical axis in the direction towards the first fluid and away from the second fluid.

Preferably, the rate of change of angle increases as the distance from the second fluid increases. It is found that particularly advantageous effects are realised if the angle changes in a more than linear relationship i.e. the angle between the wall of the chamber and the optical axis is dependent upon some non-linear function of the distance along the optical axis.

Preferably, the wall of the chamber and the optical axis are substantially parallel at one extreme point of the chamber.

Preferably, the wall of the chamber and the optical axis are substantially perpendicular at another extreme point of the chamber.

To alleviate the problem with prior art electrowetting lenses and the requirement to provide a voltage source in the region of 100V, embodiments of the present invention are configured so that the diameter of the electrowetting cell decreases more than linearly as a function of the position along the optical axis of the lens system.

When the diameter of the cell decreases more than linearly, the wall of the cell containing the fluids curves inwards, towards the optical axis.

When the contact angle of the meniscus with the wall is switched, by applying a voltage to the cell, the point of interception of the meniscus moves along the sidewall of the cell in a direction along the optical axis. This effect is a result of the fact that the volume of both liquids must remain the same when the curvature of the meniscus changes, and it occurs for any wall shape.

However, an inwardly curving wall enhances the resulting change in meniscus curvature. The required voltage to obtain a certain change in curvature is therefore smaller than in prior art devices.

As well as the fact that the required voltage to produce a certain curvature of the meniscus is reduced compared to prior art systems, it is possible to produce a greater degree of curve in the meniscus than in systems without a curved wall. This advantageously allows lenses with greater zoom factors to be constructed than would be the case if prior art techniques were used.

It is found that the switching voltage depends not only on the material properties of the liquids and the walls, but also on the geometry of the wall.

For a better understanding of the invention, and to show how embodiments of the same may be carried into effect, reference will now be made, by way of example, to the accompanying diagrammatic drawings in which:

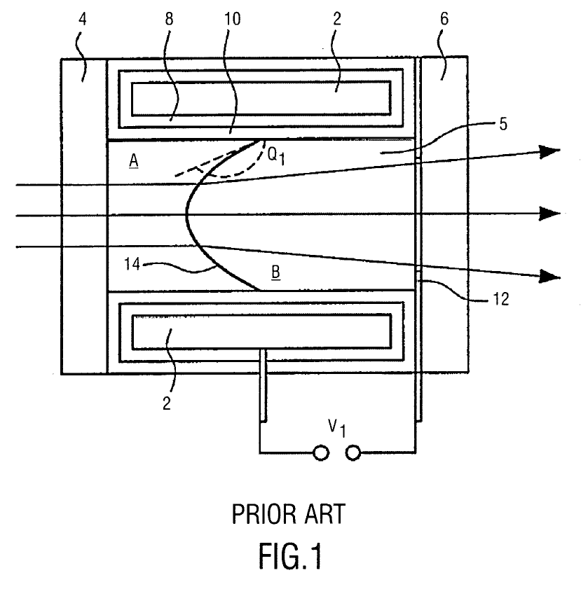

FIG. 1 shows a prior art electrowetting lens;

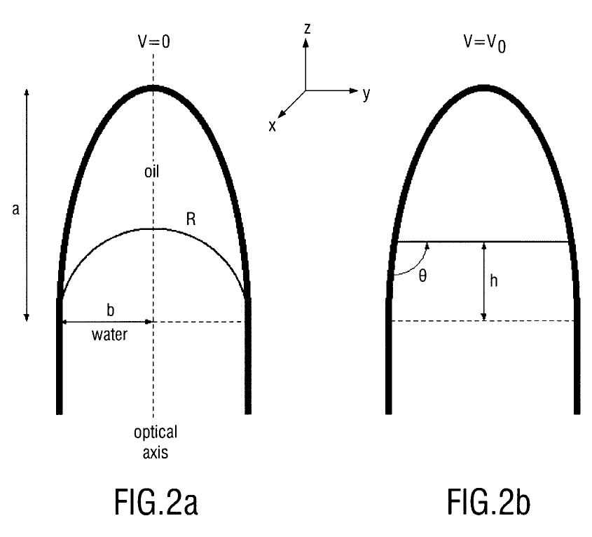

FIGS. 2a and 2b show an electrowetting lens according to an embodiment of the invention in un-switched and switched states respectively;

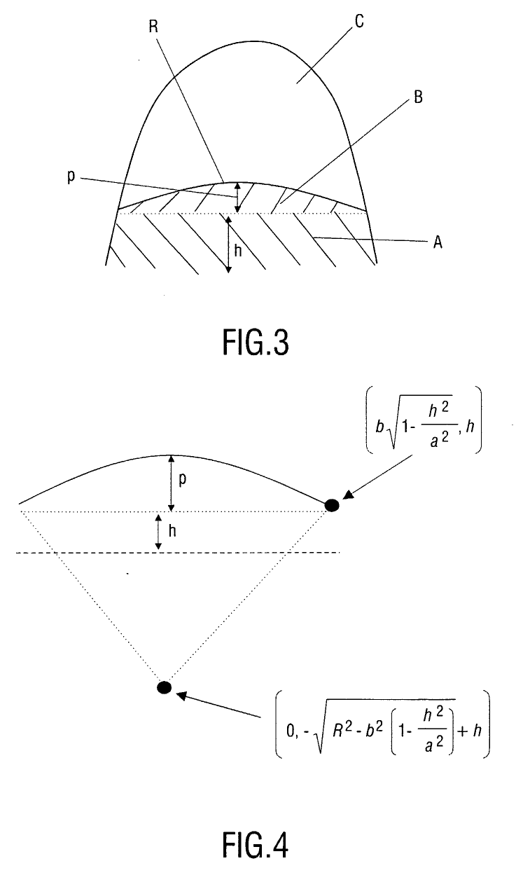

FIG. 3 shows an electrowetting lens according to an embodiment of the invention in the un-switched state; and

FIG. 4 shows a detail of the meniscus of an embodiment of the invention.

In order to understand the operation of embodiments of the present invention, it is instructive to review the operation of the prior art electrowetting lens shown in FIG. 1. This lens is described in detail in WO03/069380, and reference to this publication is invited for a full appreciation of the operation and construction of the lens.

For the present purposes, the following brief description will suffice.

The lens shown in FIG. 1 comprises a cylindrical first electrode 2 forming a capillary tube, sealed by means of a transparent front element 4 and transparent back element 6 to form a fluid chamber 5 containing two fluids. Electrode 2 may be a conducting coating applied to the inner wall of the tube.

The two fluids consist of two non miscible liquids in the form of an electrically insulating first liquid A, such as a silicone oil or an alkane, referred to herein as “the oil”, and an electrically conducting second liquid B such as water containing a salt solution. The two liquids are preferably arranged to have an equal density, so that the lens functions independently of orientation, i.e. without dependence on gravitational effects between the two liquids. This may be achieved by appropriate selection of the first liquid constituent; for example alkanes or silicone oils may be modified by addition of molecular constituents to increase their density to match that of the salt solution.

Depending on the choice of the oil used, the refractive index of the oil may vary between 1.25 and 1.60. Likewise, depending on the amount of salt added, the salt solution may vary in refractive index between 1.33 and 1.48. The fluids used in the lens of FIG. 1 are selected such that the first fluid A has a higher refractive index than the second fluid B.

The first electrode 2 is a cylinder of inner radius typically between 1 mm and 20 mm. The electrode 2 is formed from a metallic material and is coated by an insulating layer 8, formed for example of parylene. The insulating layer has a thickness of between 50 nm and 100 μm, with typical values between 1 μm and 10 μm. The insulating layer is coated with a fluid contact layer 10, which reduces the hysteresis in the contact angle of the meniscus with the cylindrical wall of the fluid chamber. The fluid chamber contact layer is preferably formed from an amorphous fluorocarbon such as Teflon AF1600 produced by DuPont™. The fluid contact layer has a thickness of between 5 nm and 50 μm. The AF1600 coating may be produced by successive dip coating of the electrode 2, which forms a homogenous layer of material of substantially uniform thickness, since the cylindrical sides of the electrode are substantially parallel to the cylindrical electrode; dip coating is performed by dipping the electrode whilst moving the electrode in and out of the dipping solution along its axial direction. The Parylene coating may be applied using chemical vapour deposition. The wettability of the fluid contact layer by the second fluid is substantially equal on both sides of the intersection of the meniscus 14 with the fluid contact layer 10 where no voltage is applied between the first and second electrodes.

A second, annular electrode 12 is arranged at one end of the fluid chamber, in this case, adjacent the back element 6. The second electrode 12 is arranged with at least one part in the fluid chamber such that the electrode acts on the second fluid B.

The two fluids A and B are non miscible so as to tend to separate into two fluid bodies separated by a meniscus 14. Where no voltage is applied between the first and second electrodes, the fluid contact layer has a higher wettability with respect to the first fluid A than the second fluid B. Due to electrowetting, the wettability by the second fluid B varies under the application of a voltage between the first electrode and the second electrode, which tends to change the contact angle of the meniscus at the three-phase line (the line of contact between the fluid contact layer 10 and the two liquids A and B). The shape of the meniscus is thus variable in dependence on the applied voltage.

When a low voltage V₁, example between 0 volts and 20 volts, is applied between the electrodes the meniscus adopts a first concave meniscus shape. In this configuration, the initial contact angle Q₁ between the meniscus and the fluid contact layer 10, measured in the fluid B, is for example approximately 140°. Due to the higher refractive index of the first fluid A than the second fluid B, the lens formed by the meniscus, here called meniscus lens, has a relatively high negative power in this configuration.

To reduce the concavity of the meniscus shape, a higher magnitude of voltage is applied between the first and second electrodes. When an intermediate voltage e.g. between 20 volts and 150 volts, depending on the thickness of the insulating layer, is applied between the electrodes, the meniscus adopts a second concave meniscus shape having a radius of curvature increased in comparison with the meniscus shown in FIG. 1. In this configuration, the intermediate contact angle between the first fluid A and the fluid contact layer 10 is, for example, approximately 100°. Due to the higher refractive index of the first fluid A and the second fluid B, the meniscus lens in this configuration has a relatively low negative power.

In the following description of a preferred embodiment of the present invention, the basic structure of the electrowetting lens is similar to that disclosed with relation to FIG. 1. All further description of the lens forming an embodiment of the present invention, will exclude specific details regarding the physical structure of the lens elements such as electrodes, front and back elements, and fluid contact layer. The skilled man will of course understand that these structures apply equally to embodiments of the present invention as they do to the discussed prior art, and may be similarly effected. The following description will instead concentrate on the shape of the electrowetting lens and its various components, which set embodiments of the present invention apart from the prior art.

A first embodiment of the invention is shown in FIGS. 2a and 2b. Conceptually, the lens is made up of a cylinder with an elliptical dome positioned on top of it. The two fluids used in the lens are an oil and a water-based solution.

It can be seen that a first extreme of the lens (shown at the bottom in this orientation), the wall of the chamber, (containing the fluids labelled oil and water), runs substantially parallel to the optical axis of the lens, shown by the dashed line. As the distance along the optical axis increases, in a direction away from the water, the wall of the chamber slopes inwards towards the optical axis i.e. the angle formed between the wall of the chamber and the optical axis decreases.

As the distance increases towards the very end of the chamber containing the oil, the angle formed between the wall and the optical axis tends towards 90° i.e. the wall of the chamber becomes orthogonal to the optical axis.

FIG. 2a shows the configuration of the lens with no voltage applied to the cell, and FIG. 2b shows the configuration with a switching voltage (Vₒ) applied.

For most oils at zero voltage (see FIG. 2a), the meniscus of the water-oil interface is a hemisphere, where the interception point of the sphere and the ellipsoid is such that it is just a half sphere in a half ellipsoid. The wall of the ellipsoid, forming the cell, is determined by the equation:

$$\frac{{x}^{2}}{{b}^{2}} + \frac{{y}^{2}}{{b}^{2}} + \frac{{z}^{2}}{{a}^{2}} = 1 \qquad ( 1 )$$

The volume of half an ellipsoid is given by:

$${V}_{ellips} = \frac{2}{3} π {ab}^{2} \qquad ( 2 )$$

The volume of half a sphere is:

$${V}_{spere} = {}_{3}^{2} π {b}^{3} \qquad ( 3 )$$

So the volume (I) occupied by the oil in the upper portion of the cell is:

$$I = \frac{2}{3} π {b}^{2} ( a - b ) \qquad ( 4 )$$

Consider now the case where the meniscus is switched by application of a voltage (Vₒ). This is shown in FIG. 2b where the meniscus is shown in a flat position at a height h above the previous intercept point between the hemisphere and the half ellipsoid.

The situation post-switching is shown in more detail in FIG. 3 where the portions labelled A and B represent water; and the portion labelled C is oil. Since the meniscus between the oil and water can not be perfectly flat, the portion of water labelled B represents the slight curvature of the meniscus in the switched position. The height p represents the height of the meniscus above the ideal flat meniscus. The height h, as before, represents the height of the ideal meniscus above the non-switched intercept point.

$$\begin{matrix}Volume B + C = \frac{2}{3} π {ab}^{2} - π {b}^{2} ( h - \frac{1}{3} \frac{{h}^{3}}{{a}^{2}} ) & ( 5 ) \\ \begin{matrix}Volume B = {\int }_{R - p}^{R} π ( {R}^{2} - {h}^{2} ) d h \\ = π ( {R}^{3} - \frac{1}{3} {R}^{3} ) - π ( {R}^{2} ( R - p ) - \frac{1}{3} {( R - p )}^{3} ) \\ = \frac{2}{3} π {R}^{3} - π {R}^{3} + π {R}^{2} p + \frac{1}{3} π ( {R}^{3} - 3 {R}^{2} p + 3 {Rp}^{2} - {p}^{3} ) \\ = \frac{1}{3} π {p}^{2} ( 3 R - p )\end{matrix} & ( 6 )\end{matrix}$$

Furthermore, we have the relation:

$$\begin{matrix}{R}^{2} - {( R - p )}^{2} = {b}^{2} = {b}^{2} ( 1 - \frac{{h}^{2}}{{a}^{2}} ) so , & ( 7 ) \\ p = R - \sqrt{{R}^{2} - {b}^{2} ( 1 - \frac{{h}^{2}}{{a}^{2}} )} & ( 8 )\end{matrix}$$

Finally, we find that volume (I) of C is given by:

$$I = \frac{2}{3} π {ab}^{2} - π {b}^{2} ( h - \frac{1}{3} \frac{{h}^{3}}{{a}^{2}} ) - \frac{1}{3} π {p}^{2} ( 3 R - p ) \qquad ( 9 )$$

This should be equal to (4). This results in the equation:

$$\begin{matrix} {p}^{2} ( 3 R - p ) = 2 {b}^{3} - 3 {b}^{2} ( h - \frac{1}{3} \frac{{h}^{3}}{{a}^{2}} ) So , & ( 10 ) \\ {( R - \sqrt{{R}^{2} - {b}^{2} ( 1 - \frac{{h}^{2}}{{a}^{2}} )} )}^{2} ( 2 R + \sqrt{{R}^{2} - {b}^{2} ( 1 - \frac{{h}^{2}}{{a}^{2}} )} ) = 2 {b}^{3} - 3 {b}^{2} ( h - \frac{1}{3} \frac{{h}^{3}}{{a}^{2}} ) \\ & ( 11 )\end{matrix}$$

Note the special case, shown in FIG. 2b:

→h=0 R=b(initial condition) (12)

Equation (11) results in a third equation for R which can be solved analytically.

In order to investigate the effect of the inwards curvature of the ellipsoid on the angle the meniscus makes with the wall, consider the case where the meniscus is switched (V=Vₒ) such that it is substantially flat. From the constraint that the volumes of the liquids remain the same we can derive the equation determining the height h. The meniscus is flat in the ideal case when R=∞ and therefore volume B=0, so we find (p=0) the relation determining h:

$$\begin{matrix} \frac{2}{3} b = h - \frac{1}{3} \frac{{h}^{3}}{{a}^{2}} Solution & ( 13 ) \\ h = - \frac{( 1 - i \sqrt{3} ) {a}^{2}}{2 {( - {a}^{2} b + \sqrt{- {a}^{6} + {a}^{h} + {b}^{2}} )}^{1 / 3}} - \frac{1}{2} ( 1 + i \sqrt{3} ) {( - {a}^{2} b + \sqrt{- {a}^{6} + {a}^{h} {b}^{2}} )}^{1 / 3} & ( 14 )\end{matrix}$$

In the case a>>b we find

$$h \approx \frac{2}{3} b \qquad ( 15 )$$

If we let b=1

| a | h |
|---|---|
| 1.1 | 0.817 |
| 1.5 | 0.723 |
| 2 | 0.694 |
| 5 | 0.670 |
| 10 | 0.667 |
| ∞ | 0.677 |

The final item requiring characterisation is the angle θ between the meniscus and the wall. Consider FIG. 2b. At the interception point at height h the normal vector on the ellipse is given by:

$${{n}^{->}}_{ellips} = ( \frac{\sqrt{1 - \frac{{h}^{2}}{{a}^{2}}}}{\sqrt{1 - \frac{{h}^{2}}{{a}^{2}} ( 1 - \frac{{b}^{2}}{{a}^{2}} )}} , \frac{\frac{bh}{{a}^{2}}}{\sqrt{1 - \frac{{h}^{2}}{{a}^{2}} ( 1 - \frac{{b}^{2}}{{a}^{2}} )}} ) \qquad ( 16 )$$

For the normal vector on the sphere we find from FIG. 3 that the normalised normal vector is then

$${{n}^{->}}_{sphere} = \frac{1}{R} ( b \sqrt{1 - \frac{{h}^{2}}{{a}^{2}}} , \sqrt{{R}^{2} - {b}^{2} ( 1 - \frac{{h}^{2}}{{a}^{2}} )} ) \qquad ( 17 )$$

So the cosine of the angle θ is found by taking the inner product of the normal vectors:

$$cos θ = \frac{1}{R} \frac{b ( 1 - \frac{{h}^{2}}{{a}^{2}} ) + \frac{bh}{{a}^{2}} \sqrt{{R}^{2} - {b}^{2} ( 1 - \frac{{h}^{2}}{{a}^{2}} )}}{\sqrt{1 - \frac{{h}^{2}}{{a}^{2}} ( 1 - \frac{{b}^{2}}{{a}^{2}} )}} \qquad ( 18 )$$

At the special case where the interface is flat and R=∞ we have:

$$cos θ = \frac{\frac{bh}{{a}^{2}}}{\sqrt{1 - \frac{{h}^{2}}{{a}^{2}} ( 1 - \frac{{b}^{2}}{{a}^{2}} )}} \qquad ( 19 )$$

with h given by (14).

In the case of a cylindrical cell (a=∞), there is a flat interface between the oil and water where cos θ=0. Let the corresponding voltage to reach this flat interface be V₀. It is well known in electrowetting that cos θ scales with the voltage squared, so we can write

$$cos θ = - 1 + \frac{{V}^{2}}{{V}_{0}^{2}} \qquad ( 20 )$$

In the case of an elliptical cell (a=finite), in order to have a flat interface, cos θ>0.

This occurs at:

$$cos θ = \frac{\frac{bh}{{a}^{2}}}{\sqrt{1 - \frac{{h}^{2}}{{a}^{2}} ( 1 - \frac{{b}^{2}}{{a}^{2}} )}} \qquad ( 21 )$$

with h given by (14).

In table 1, below, for various values of a/b the height h and the angle have been tabulated.

TABLE 1
Table of the various parameters.

| | | | | x/b = |
|---|---|---|---|---|
| a/b | h/b | cosθ | V/V₀ | (1 − h²/a² h)^{1/2} |
| 1.1 | 0.817 | −0.710 | 0.539 | 0.67 |
| 1.5 | 0.723 | −0.344 | 0.810 | 0.88 |
| 2 | 0.694 | −0.182 | 0.904 | 0.94 |
| 5 | 0.670 | −0.027 | 0.986 | 0.99 |
| 10 | 0.667 | −0.007 | 0.996 | 1.00 |
| Infinite | 0.667 | −0.000 | 1.000 | 1.00 |

From table 1 it follows that when the ratio a/b becomes less than 5, the required voltage becomes significantly lower than when the wall is not curved in the z direction. The reduction becomes almost a factor of two for a/b=1.1.

Although the specific case where the electrowetting cell has an ellipsoid as wall, it will be readily appreciated by a person skilled in the art that any type of inwards curving wall will lead to a switching voltage reduction. Therefore, other geometrical shapes having similar properties to ellipsoids can be used to enhance the switching operation of an electrowetting lens.

Lenses of the type described find general application in a range of miniature and hand-held imaging apparatus. Particular applications include portable cameras, camcorders and imaging communication devices, such as telephones.

The advantages offered by embodiments of the present invention allow the construction of optical devices requiring lower voltage supplies to yield a given range of zoom factors. Alternatively, voltage sources using similar ranges as used in prior art devices can produce a greater range of zoom values.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A variable focus lens, having an optical axis, comprising:
a fluid chamber, the fluid chamber comprising a first fluid and an axially displaced second fluid, the fluids being non-miscible, in contact over a meniscus and having different indices of refraction;
a fluid contact layer arranged on the inside of the chamber wall;
a first electrode separated from the first fluid and second electrode by the fluid contact layer;
a second electrode acting on the second fluid;
the fluid contact layer having a wettability by the second fluid which varies under the application of a voltage between the first electrode and the second electrode, such that the shape of the meniscus varies in dependence on said voltage;
wherein the fluid chamber is shaped such that an angle formed between the wall of the chamber and the optical axis decreases along the length of the optical axis.

2. A lens as claimed in claim 1 wherein the first fluid includes an insulating fluid and the second fluid includes a conducting fluid.

3. A lens as claimed in claim 1 wherein the angle decreases along the optical axis in the direction towards the first fluid and away from the second fluid.

4. A lens as claimed in claim 1 wherein the rate of change of angle increases as the distance from the second fluid increases.

5. A lens as claimed in claim 1 wherein the wall of the chamber and the optical axis are substantially parallel at one extreme point of the chamber.

6. A lens as claimed in claim 5 wherein the wall of the chamber and the optical axis are substantially perpendicular at another extreme point of the chamber.
